(19) United States
(12) Patent Application Publication
(10) Pub. No.: US 2023/0249502 A1
(43) Pub. Date: Aug. 10, 2023

(54) METHOD FOR EXTERIOR NOISE SIMULATION OF A TIRE

(71) Applicant: Bridgestone Europe NV/SA [BE/BE], Zaventem (BE)

(72) Inventors: Marco Emiliani, Rome (IT); Gaetano Fortunato, Rome (IT); Vincenzo Ciaravola, Rome (IT)

(21) Appl. No.: 18/013,192

(22) PCT Filed: Jul. 5, 2021
(86) PCT No.: PCT/EP2021/068533

§ 371 Date: Dec. 27, 2022

(30) Foreign Application Priority Data
Jul. 7, 2020 (IT) 102020000016372

(51) Int. Cl. B60C 99/00

(52) U.S. Cl. CPC B60C 99/006

(57) ABSTRACT

A simulation method of exterior noise generated by a rolling tyre, in particular Pass-By Noise (PBN), which method comprises the following steps: (iv) providing a FEM structural model of a rolling tyre including modelled pattern features, wherein an instant position of each node is calculated; (v) providing the tyre structural model as input to a mapping procedure which outputs a tyre acoustic model, which procedure comprises the following sub-steps: (iia) for each target node of the acoustic mesh, a number of closest input nodes of the input structural mesh are selected; (iib) a value of a vibration variable for the target node is calculated starting from the values of such variable of the closest input nodes; (iic) for each target note a FFT (Fast Fourier Transform) is calculated to obtain the vibration variables in frequency domain; (vi) calculating the sound pressure field generated by the tyre based upon the tyre acoustic model.

### FIELD OF THE INVENTION

The present invention relates to a computer-implemented method for the simulation of exterior noise generated by a tire, in particular the Pass-By Noise (PBN) of a rolling tire. The method is suited for all tire exterior noise issue, i.e. tire sound power calculation or tire radiated noise.

### BACKGROUND OF THE INVENTION

Tire exterior noise reduction has become a very challenging task for designers and manufactures, particularly in consideration of the important trade-off with other performances and current/future regulation limits.

Noise reduction can be achieved by construction changes, i.e. by acting upon materials and geometries of tire components, or by a dedicated design of the geometrical features of the tire tread pattern.

In recent times, acoustic FEM (Finite Element Method) simulation has been used as a tool to assist engineers toward an effective improvement of tire exterior noise, by taking into account pattern and construction features.

However, also FEM simulation techniques and tools available in the art show important limitations. In particular, the current capability of FEM tools is limited to acoustic simulation of a non-rolling tire, while there is no consolidated approach to deal with the more realistic case of a rolling tire with a detailed tread pattern model.

A critical point is also the mapping process of the ty tire e acoustic behaviour, wherein different interpolation techniques may have different accuracy and may lead to diverging results. Computational time, also, is a critical parameter, considering the high number of nodes and time steps needed for proper tire modelling.

The presence of tire pattern, too, is an important element in the simulation process, because lateral tire slots cause the tire geometry to be not axial-symmetric, a condition in which some known art interpolation algorithms might not work.

Therefore, the current FEM techniques and tools available for simulating the tire acoustic behaviour do not prove effective and efficient in assisting tire designers and manufactures for analysing and reducing the tire exterior noise, particularly PBN.

### SUMMARY OF THE INVENTION

The technical problem underlying the present invention is therefore to overcome at least some of the drawbacks mentioned above with reference to the state of the art.

The above problem is solved by a simulation method according to claim 1. Preferred features of the invention are the object of the dependent claims.

The invention provides a method and system for exterior noise simulation of a full pattern rolling tire. In particular, the simulation can include the effects of all pattern features—e.g. lateral slots, sipes, chamfer—and not only grooves as in an axial-symmetric tire model.

In preferred embodiments thereof, the method comprises the three main steps summarized below.
FEM simulation of a rolling tire is performed. Preferably, an explicit FEM simulation is performed on a tire having all construction and pattern features of a real tire. In the simulation environment, the tire is loaded against a reference surface (road or drum) and it is rotated at a desired speed. Reference surface could be either perfectly smooth or including more realistic geometrical features of real asphalts (e.g. micro or macro roughness). Preferably, this simulation is performed in a time domain using a Lagrangian approach. In preferred embodiments, tire is represented by a mesh with nodes and tire vibration is calculated, at each sampled instant of time, for each node that changes position over time. In this way, a vibration map is obtained for each sampled instant of time. In order to distinguish it from the subsequent acoustic simulation step, the FEM simulation of rolling tire will be hereafter defined as ‘structural’ simulation and the mesh used as ‘structural mesh’. The tire structural mesh is a mesh made of 3D or 2D elements including all the tire components and features (i.e. from the interior of tire to the external surface—tread—in contact with ground).
A mapping process is performed to allow running acoustic simulation of the subsequent step starting from structural simulation results of the previous step. In fact, considering that most efficient acoustic solvers work in the frequency domain with a stationary mesh (nodes not moving), it is hardly possible to directly use data coming from the structural simulation of the previous step (where nodes are moving over time due to tire rolling).

The mapping process is based upon a customized algorithm which transfers the tire rolling simulation output, i.e. the vibration maps or rolling mesh (i.e. structural mesh), into a non-rolling mesh (hereafter called tire acoustic mesh). Preferably, this step converts vibration from the Lagrangian domain (rolling mesh) into a Eulerian domain (non rolling mesh), the latter being used for acoustic simulation. The tire acoustic mesh is a mesh made of only 2D elements and copying/reproducing (but not necessarily coinciding with) the external layer (or skin) of the tire structural mesh. In specific implementations, the tire acoustic mesh is simplified (e.g. coarser and with smaller detail removed) with a level of resolution (i.e. mesh size) depending upon the frequency range of interest.
Acoustic simulation is performed. The vibration field obtained from the mapping process of the previous step is used as boundary condition of a FEM simulation of the exterior acoustic behaviour of the tire.

The invention provides a tool for the tire designing stage, e.g. for both mould design and property specification, for all tires having an exterior noise requirement.

In particular, the simulation method allows improving tire by design, rather than replacing physical experimental tests.

Other advantages, features and application modes of the present invention are explained in the following detailed description of specific embodiments, provided by way of example and not with limitative purpose.

### BRIEF DESCRIPTION OF THE DRAWINGS

Reference will be made to the figures of the annexed drawings, wherein:

FIG. 1 shows structural and simplified acoustic tire mesh that are used during a mapping process of a simulation method step according to a preferred embodiment of the invention;

FIG. 2 shows a schematic representation of a specific simulation sub-step according to a preferred embodiment of the invention;

FIGS. 3A and 3B show each a graph representing vibration maps of a tire (in particular the ODS, Operational Deflection Shape) obtained by a preferred embodiment of the invention, at a respective frequency;

FIG. 4A represents a noise spectrum obtained from an experimental test, while FIG. 4B represents a noise spectrum obtained from an embodiment of the method according to the invention; an objective of the present invention is to have similar spectral shape so that same noise generation phenomena are represented;

FIG. 5 shows an exemplary subdivision of structural and acoustic tire meshes in lateral section to speed up interpolation during the mapping process of FIG. 1.

### DETAILED DESCRIPTION OF PREFERRED EMBODIMENTS OF THE INVENTION

Exterior noise of a tire, in particular Pass-By Noise (PBN), is due to vibrations induced by tire/road interaction that convert into noise (vibro-acoustic approach). According to the invention, acoustic simulation of a rolling tire is performed. In preferred embodiments, the simulation is based upon the following steps.

In a first step, structural simulation of a rolling tire is performed and tire vibration on the exterior tire surface—i.e. at the tire contour—is calculated.

This step can be performed by using Finite Element Methods (FEMs) and Analysis (FEA) tools currently available in the art.

Preferably, this step entails developing or providing a complete tire model, including construction and pattern element geometries. The tire pattern features—e.g. slots, sipes and so on—may make the model non-axialsymmetric and generate (further) vibrations during rolling.

Preferably, the vibration is expressed as velocity, acceleration or displacement of nodes of a mesh.

The result of this step is a vibration model, or map, of the tire, for each sampled instant of time, as explained in detail below.

In the simulation environment, the inflated tire is modelled and loaded on, i.e. associated with, a reference surface, wherein the tire is rotated at a certain speed for a certain time period.

During the simulation time period, the vibration of exterior tire, i.e. the position, speed or acceleration of each node, is stored for each sampled time instant or frame (i.e. time increment of the simulation), wherein the time sampling pitch can be chosen depending upon the frequency range of interest. In this way, a vibration map for each sampled instant of time is obtained.

As said above, the output of this step is a structural model, mesh or vibration map, of a rolling tire, wherein the instant position of each node is defined by the tire structural deformation as deriving from vibration and pressure and load application.

This step may be performed, e.g., by using the Abaqus Explicit® software tool commercially available or by equivalent means. Explicit FEM solver is particularly suited to simulate transient dynamic events such as the periodic tread block impact on ground during tire rolling. Differently from implicit solvers, explicit software solves the equation of motions through time including all the inertial effects and offer many computational advantages with complex non linear problems.

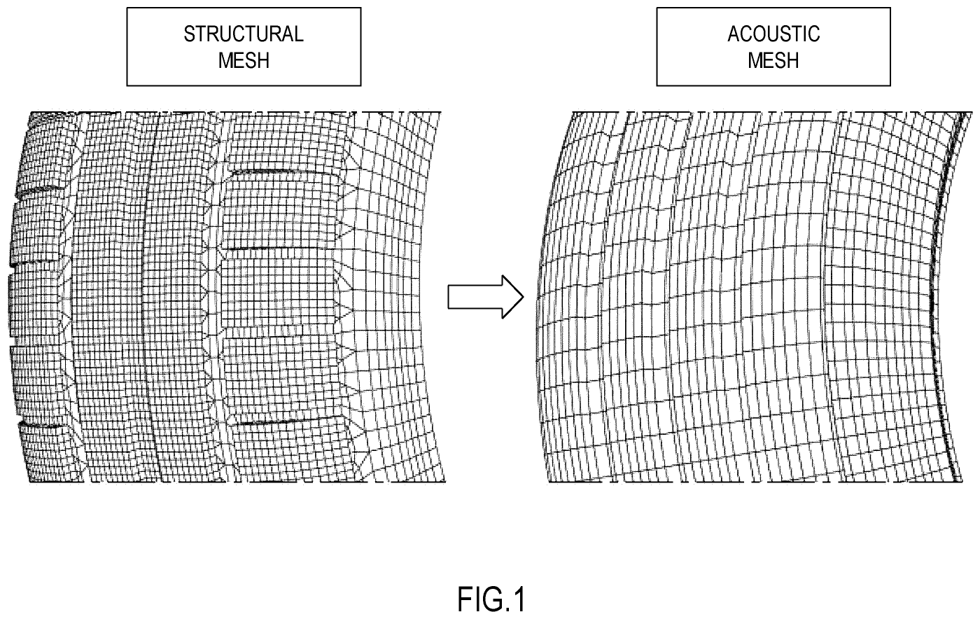

As exemplified in FIG. 1, in a second step the method provides mapping the results from the structural rolling mesh obtained by the above structural simulation step into a (stationary, non rolling) acoustic mesh. Preferably, this step converts the vibration map, i.e. the rolling structural mesh obtained in the first step, from the Lagrangian domain into a Eulerian domain, the latter being subsequently used for noise simulation.

According to preferred embodiments, the mapping is obtained as follows.

A vibration variable of the target acoustic mesh is selected, which variable is preferably chosen among velocity, acceleration and displacement. Velocity and acceleration may be preferred over displacement.

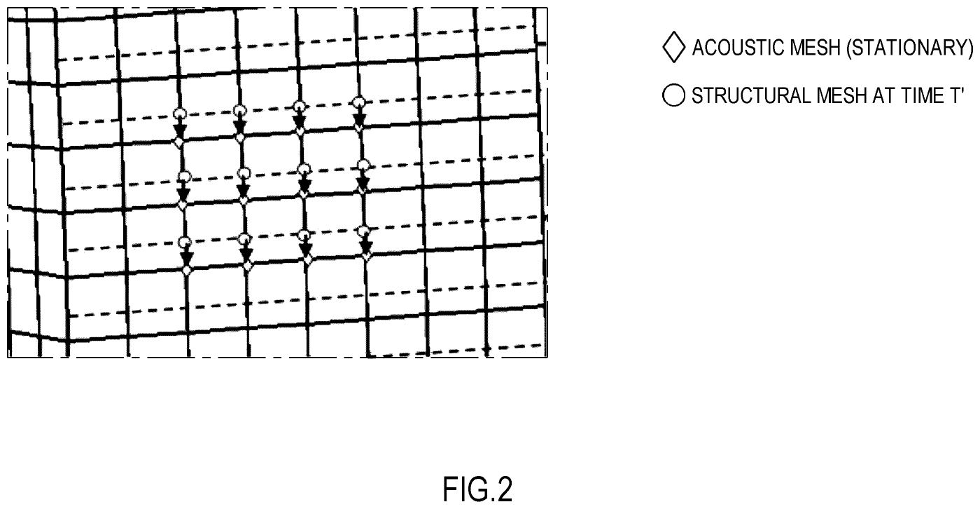

As exemplified in FIG. 2, for each sampled time instant the vibration variable is calculated as follows.
For each node of the acoustic mesh, a number of closest nodes of the structural mesh is selected.
An interpolation between nodes of the structural and acoustic mesh is performed to transfer the vibrational results to the latter mesh. In particular, a weighted average of the vibration variable for the node of acoustic mesh is calculated, starting from the values of said variable of the selected closest nodes on structural mesh.
The number of closest nodes of structural mesh are in the preferred range of 1 to 8 and an inverse distance weighted interpolation is used:

$${v}_{j} = A {\sum }_{i = 1}^{n} \frac{{v}_{i}}{{d}_{i , j}}$$

wherein:

A=normalization factor

vⱼ=vibration at node j of acoustic mesh

vᵢ=vibration at node i of the structural mesh

d_{i,j}=distance between node i of the structural mesh and node j of acoustic mesh.

The numerical method is intended to be applied to a FE model of a real tyre having all pattern features (including small pattern features like sipes) leading to a very heavy mesh (with number of nodes/elements that can be >1 M) Interpolation between two meshes (Lagrangian and Eulerian) of such magnitude, to be repeated for all the time step of simulation (depending of sampling frequency but typically >1000-2000 time increment) would became computationally very demanding.

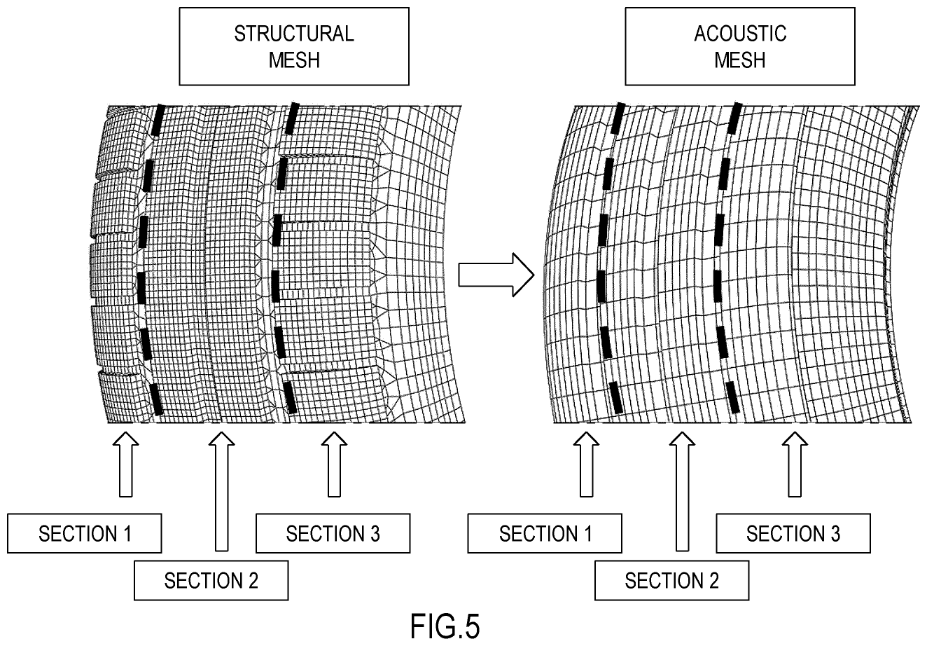

In order to reduce computational time both the Lagrangian (input) and Eulerian (target) meshes might be divided into sections in lateral direction (in the range of 2-20 sections) obtained orthogonally to the tire rolling axis, as shown in FIG. 5. The interpolation is done separately within each corresponding tire section that have a lower number of nodes, drastically reducing the overall computational time.

After repeating the above interpolation process for all time frames, a time history is available for all nodes of the acoustic (target) mesh in conjunction with the respective values of the vibration variable.

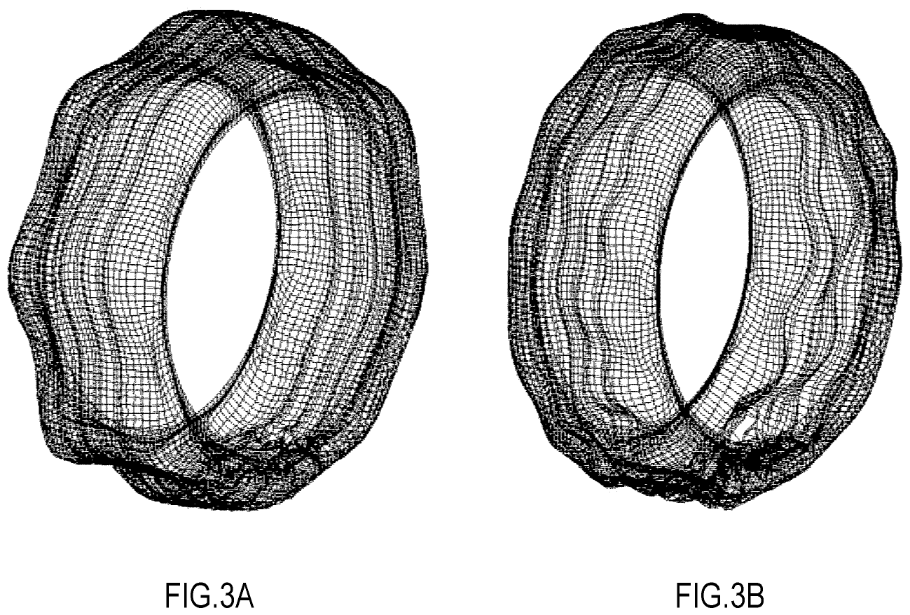

For each node, a FFT (Fast Fourier Transform), or equivalent tool, is therefore calculated to have the vibration variable in frequency domain. The result of this step is the tire vibration map (ODS—Operational Deflection Shape) at any specific frequency, as exemplified in the graphs of FIGS. 3A and 3B were the displacement of each node of stationary mesh is represented (in logarithmic scale) for a given frequency band (low frequency band 100-300 Hz in FIG. 3A and high frequency band 400-600 Hz in FIG. 3B).

Preferably, in said step operation in a range of about 20-2000 Hz, preferably 500-2000 Hz, is provided.

In specific embodiments, the acoustic mesh can be a simplified one with respect to mesh size (coarser mesh) and/or pattern elements to be included (e.g. only longitudinal grooves may be modelled). The use of a simplified mesh will reduce computational time with potentially minimum impact on results. In fact, when using lower spatial resolution of acoustic mesh (i.e. less number of nodes and elements) the interpolation and acoustic simulation steps will be faster (while no change of simulation time for structural simulation).

This step can be implemented by Matlab® or any equivalent calculation code or tool.

In a third step, the stationary mesh obtained in the second step is converted into noise, in particular as propagating in a free-field condition, by an acoustic simulation tool. The vibration data as mapped in the second step are used as boundary condition for this acoustic simulation.

The method calculates the acoustic response (Sound Pressure field) in any position of space for each sampled instant of time, thus replicating experimental tests, like those measuring PbN.

This step can be performed by using commercially available acoustic solvers. A preferred tool for this step is based upon acoustic FEM, e.g. using commercially available software such as Siemens VIRTUALLAB®, FFT ACTRAN® or Dassault Systemes WAVE6®. A technique known as PML (Perfectly Matching Layer) may be used for simulating free-field propagation Main advantage of PML use is that only a thin layer of acoustic FEM domain has to be modelled.

Alternatively, BEM (Boundary Element Method) tools can be used.

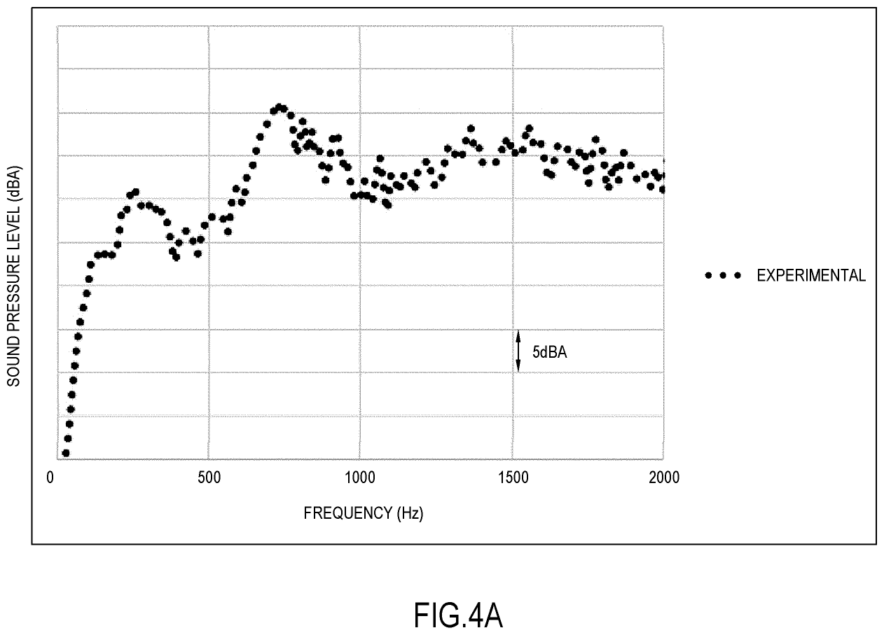

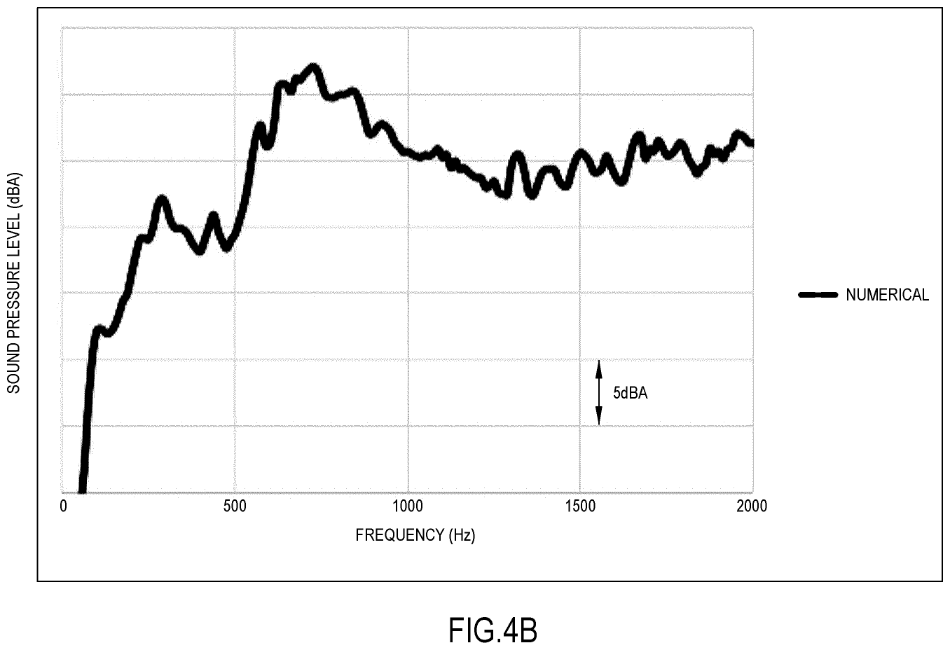

FIGS. 4A and 4B show a graph representing the method performance vs experimental tests. The graph shows a comparison of the Sound Pressure Level (SPL) spectra at 7.5 m from the tire measured with microphones (FIG. 4A—dot line) and simulated with an embodiment of the simulation method according to the invention (FIG. 4B—solid line).

The present invention has been described so far with reference to preferred embodiments. It is intended that there may be other embodiments which refer to the same inventive concept as defined by the scope of the following claims.

1-10. (canceled)

11. A computer-implemented method of exterior noise simulation generated by a rolling tire, the method comprising:
providing a structural model of a rolling tire including modelled pattern features comprising one or more of lateral slots, sipes, and chamfers, wherein the structural model includes a structural mesh with nodes, wherein an instant position of each node is calculated based upon tire structural deformation caused by vibration due to interaction with a reference modelled surface;
providing the tire structural model as input to a mapping procedure which outputs a tire acoustic model including an acoustic mesh with nodes, wherein the mapping procedure further comprises, for each respective node of the acoustic mesh:
a number of closest nodes of the structural mesh in a certain sampled time instant are selected;
a value of a vibration variable for the respective node is calculated starting from the values of such variable of the closest nodes of the structural model, as a weighted average of the values of such variable of the closest nodes, wherein the weighting average is calculated using an inverse distance criterion;
wherein the vibration variable is obtained in frequency domain; and
calculating a sound pressure field generated by the tire acoustic model, wherein the vibration variable is used as a boundary condition.

12. The method of claim 11, wherein the structural model is a Finite Element (FE) model.

13. The method of claim 11, wherein for each node of the acoustic mesh, 1 to 8 of the closest nodes of the structural mesh in a certain sampled time instant are selected.

14. The method of claim 11, wherein the vibration variable for each respective node of the acoustic mesh is obtained in frequency domain by an FFT (Fast Fourier Transform).

15. The method of claim 11, wherein the structural model of the rolling tire is a model of an axial-symmetric tire or of a non-axial-symmetric tire.

16. The method of claim 11, wherein the vibration variable is selected from one or more of a group consisting of: velocity; acceleration; and displacement.

17. The method of claim 11, wherein the mapping procedure provides taking into account only an instantaneous position of each node, and excludes angular position and angular tyre velocity.

18. The method of claim 11, wherein an explicit Finite Element Method (FEM) solver is used for obtaining the structural model of the rolling tire.

19. The method of claim 11, wherein the step of obtaining the vibration variable in frequency domain operates in a range of about 20-2000 Hz.

20. The method of claim 19, wherein the step of obtaining the vibration variable in frequency domain operates in a range of about 500-2000 Hz.

21. The method of claim 11, wherein the mapping procedure further comprises, for each respective node of the acoustic mesh, that both structural and acoustic mesh are divided into lateral subsections, and the other steps of the mapping procedure are performed individually on each subsection.

22. The method of claim 21, wherein the structural and acoustic mesh are divided into 2 to 20 lateral subsections.

23. The method of claim 11, wherein the weighted average is calculated as:
$${v}_{j} = A {\sum }_{i = 1}^{n} \frac{{v}_{i}}{{d}_{i , j}}$$
wherein: A=a normalization factor; vⱼ=vibration at node j of the acoustic mesh; vᵢ=vibration at node i of the structural mesh; d_{i,j}=a distance between node i of the structural mesh and node j of the acoustic mesh.

24. The method of claim 11, for simulating Pass-By Noise (PBN) as the exterior noise generated by the rolling tire.

25. A designing method of a tire, which includes the computer-implemented method of claim 11.

26. A manufacturing method of a tire, which includes the computer-implemented method of claim 11.
